(19) United States
(12) Patent Application Publication
(10) Pub. No.: US 2010/0061540 A1
(43) Pub. Date: Mar. 11, 2010

(54) Video media composition ring tones

(76) Inventor: Christopher Lamont Dickens, Jacksonville, FL (US)

Correspondence Address: Christopher L. Dickens, 8379 Hedgewood dr., Jacksonville, FL, 32216, US

(21) Appl. No.: 12/283,124

(22) Filed: Sep. 10, 2008

(51) Int. Cl. H04M 3/42

(52) U.S. Cl. 379/207.16

(57) ABSTRACT

A method is disclosed for determining properties of an output signal that notifies a user of an incoming message or call, based on information that is available to and associated with the user's telecommunications terminal. In particular, in the illustrative embodiment one or more properties of a motion movie piece, and or a music video piece. A video piece in entirety or in short, repeating or not repeating as a ring tone such as animated video, volume, tempo, pitch, rhythm, etc. are valued accordingly in value e.g. faster versus slower, louder versus softer, etc. One or more properties of animated video or text if selected are also varied accordingly.

### BACKGROUND OF INVENTION

When telecommunications terminal 100 receives a message, it notifies its user of the messages arrival or of the associated incoming call if one is occurring by playing a video/audio piece as a “ring tone” or (Video Ring Tone) [VRT] via speaker 105 and by displaying visual information (video piece) via display 105. Telecommunications terminal 100 might play a particular video piece for all incoming messages, or a video piece that is associated with a category of callers (e.g., a video ring tone for friends, a video ring tone for family members, a video ring tone for contacts, etc.) or a video ring tone that is associated with an individual caller, etc. FIG. 2 depicts telecommunications terminal 100 (wireless telephone, a personal digital assistant [PDA], etc.) in the prior art. Telecommunications terminal 100 is capable of receiving messages (e.g., incoming voice mail notification, e-mail messages, multimedia message services [MMS] messages, Instant messaging [IM] messages, etc.), that originate from other telecommunications terminal via a network such as the Public Switched Telephone Network (PSTN.), a wireless cellular network, a wireless local-area network etc. Similarly, telecommunications terminal 100 might display a message (e.g., “Incoming call”, Incoming call: Jennifer Dickens”, “Incoming call: 555-555-5555”, etc.)

### FIELD OF INVENTION

The present invention relates to telecommunication equipment (mobile devices) in general, and in particular, to a telecommunications terminal that uses media composition (or video pieces) as an alert of an incoming message and also intelligently decides how to alert the user to the arrival of an incoming message.

### SUMMERY OF THE INVENTION

The present invention enables notifying a telecommunications terminal user of an incoming message, based on media composition that is purchased and downloaded from a media web client (web store) to a telecommunications terminal and assigned as a motion video/audio ring tone and also based on information from one or more call logs that are associated with one or more telecommunications terminals of the user. For example, if a telecommunications terminal plays the quote from the original movie (That is purchased and downloaded from a media web store) “A Few Good Men”, Jack Nicholson's, “YOU CAN'T HANDLE THE TRUTH!” in a ring tone. The video ring tone may be played in a variety of ways, depending on the attributes of the message. At a brighter video, and louder volume when a call from a given caller has already been missed at least once without a return call having been placed to the caller. With a visual video piece be it motion picture or music video accompanied by the audio of its originator when receiving a call from a particular caller for the first time modifying the values of properties such as video brightness, volume and tempo does not change the function of the identity of the video piece (music video, or motion picture piece) is independent of these properties and, therefore, the video piece remains recognizable. Written software that enables a cellular device to use or assign an animated video/audio piece (motion picture, or music video) as a ring tone or in a ring tone.

### BRIEF DESCRIPTION OF DRAWINGS

FIG. 1 Depicts a block diagram of the salient components of telecommunications terminal 90, in the prior art.

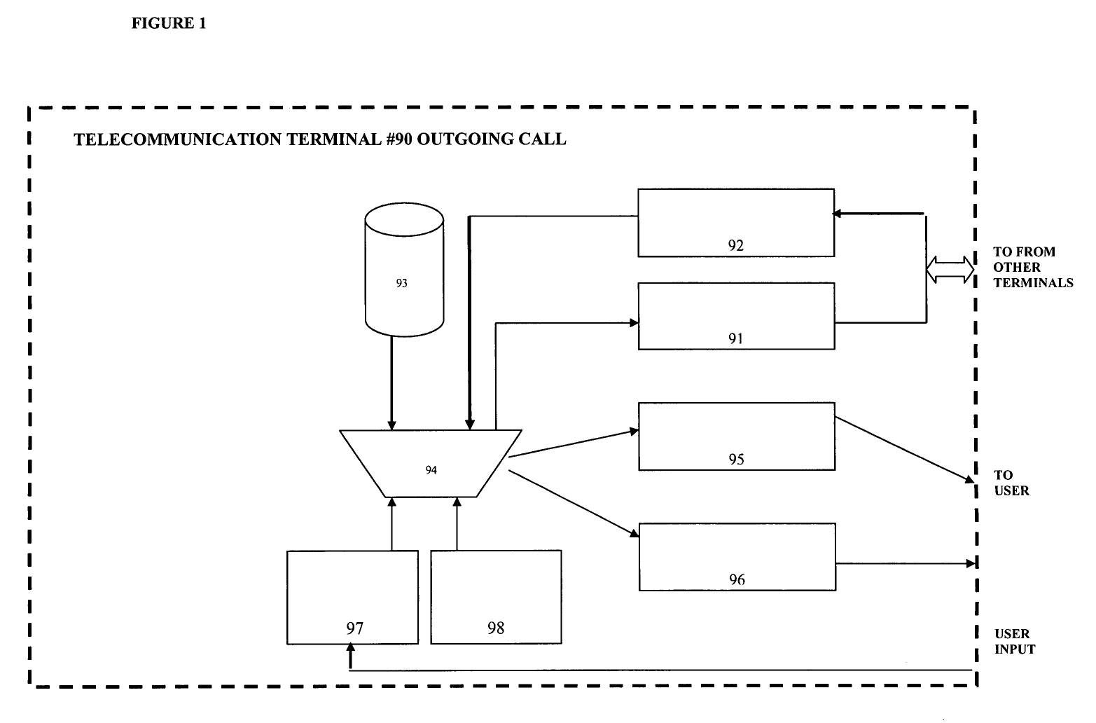

FIG. 2 Depicts a block diagram of the salient components of telecommunications terminal 100, in accordance with the illustrative embodiment of the present invention.

FIG. 3 Depicts a flowchart of salient tasks of telecommunications terminal 100 upon receiving an incoming message, in accordance with the illustrative embodiment of the present invention.

FIG. 4 Depicts a detailed flowchart of tasks 302, as shown in FIG. 3, in accordance with the illustrative embodiment of the present invention.

FIG. 5 Depicts a detailed flowchart to task 301, as shown in FIG. 3 in accordance with the illustrative embodiment of the present invention.

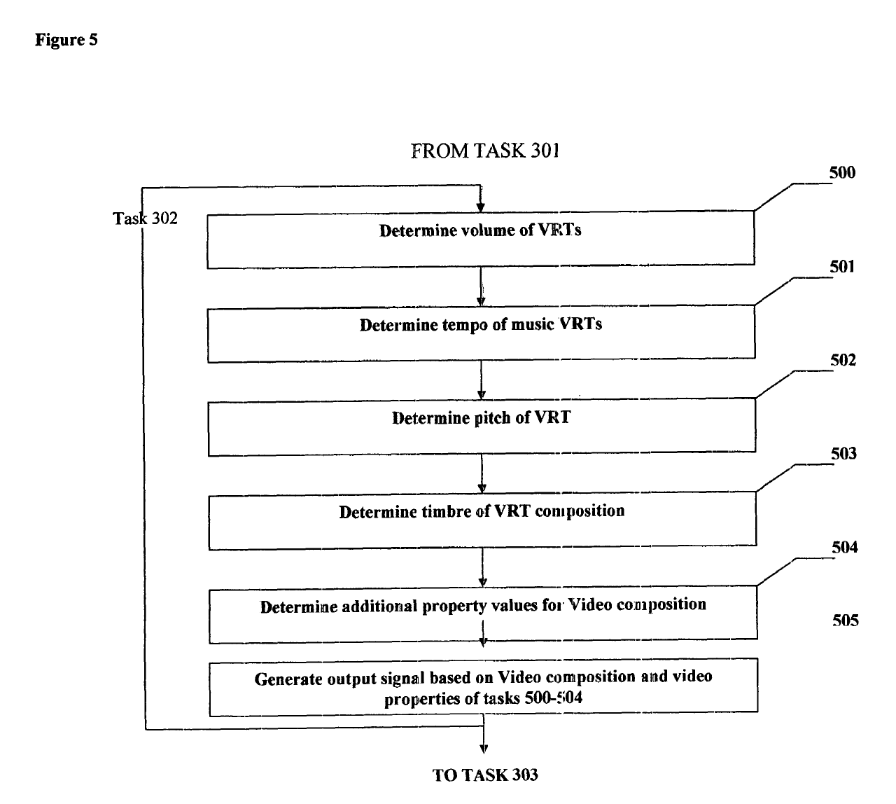

FIG. 6 Depicts a illustrative organization of information of call log 600 in accordance with the illustrative embodiment of the current invention.

### DETAILED DESCRIPTION

The term appearing below is given the following definition for use in this description and the appended claims.

For the purposes of this specification and claims, “media composition” is defined as a piece of motion video/audio. (e.g., motion video piece with original audio, or VRT Video Ring Tone.)

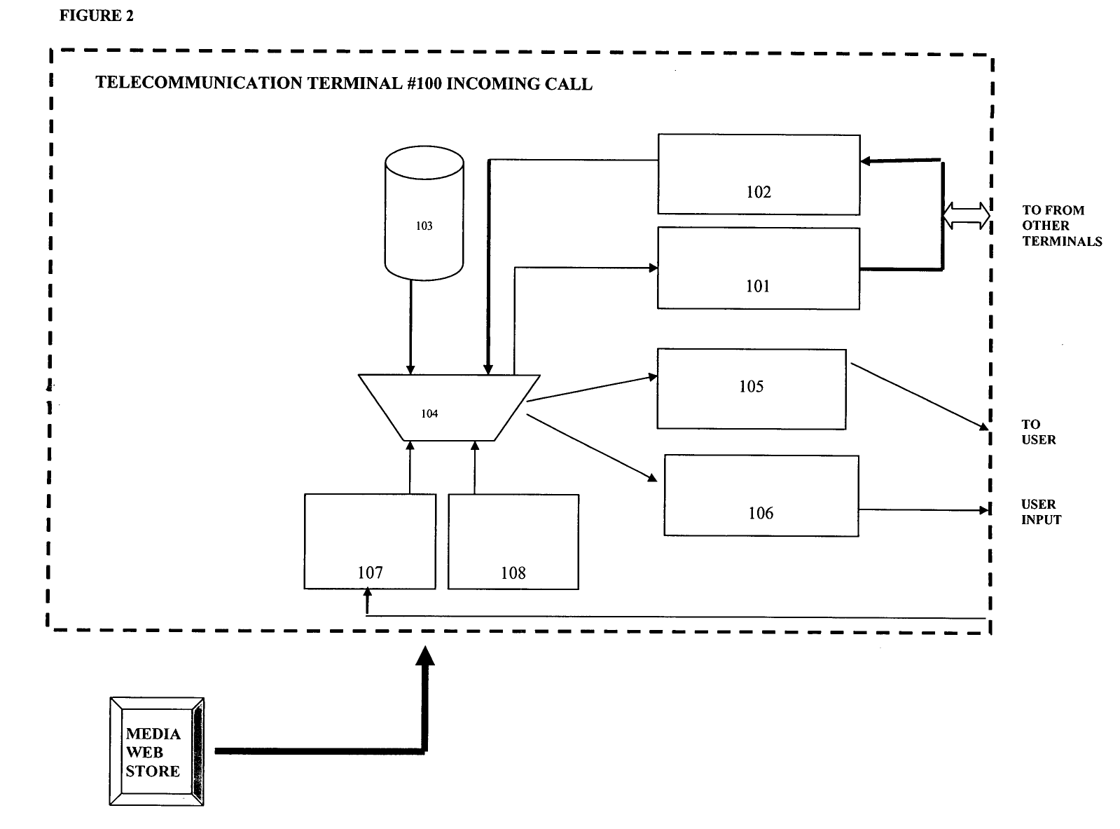

FIG. 2 depicts telecommunications terminal 100 (or “terminal 100”) in accordance with the illustrative embodiment of the present invention. As shown in FIG. 2 terminal 100 comprises speaker 105 and display 106 like speaker 95 of telecommunications terminal 90 is capable of generating audio from it's original motion video (e.g., video ring tones etc). Display 106 like display 96 of telecommunications terminal 90 is capable of displaying motion video (e.g., media composition etc).

FIG. 2 depicts a flow chart of components of terminal 100 in accordance with the illustrative embodiment of the present invention. As shown in FIG. 2 terminal 100 comprises receiver 101, processor 104, memory 103, transmitter 102, speaker 105, display 106, interconnected as shown.

Receiver 101 receives signals sent from other telecommunications terminal (e.g., via the Public Switched Telephone Network [PSTN], via a Code Division Multiple Access [CDMA] base station, etc.) and forwards the information encoded in these signals to processor 104, in well known fashion. It will be clear to those skilled in the art, after reading this disclosure, how to make and use receiver 101.

Processor 104 is a general-purpose processor that is capable of reading data from and writing data into memory 103, of sending signals to speaker 105, and display 106 in well known fashion, and of executing the tasks described below and with respect to FIG. 2 In some alternative embodiments of the present invention, processor 104 might be a special-purpose processor. In either case, it will be clear to those skilled in the art, after reading this disclosure, how to make and use processor 104.

Memory 103 stores data and executable instructions, as is well known in the art, and might be any combination of random access memory (RAM), flash memory, disk drive, etc. It will be clear to those skilled in the art, after reading this disclosure, how to make and use memory 103.

Transmitter 102 receives information from processor 104 and transmits signals that are encoded with this information to other telecommunications terminals (e.g., via the Public Switched Telephone Network [PSTN], via a Code Division Multiple Access [CDMA] base station, etc.) in well known fashion. It will be clear to those skilled in the art, after reading this disclosure, how to make and use transmitter 102.

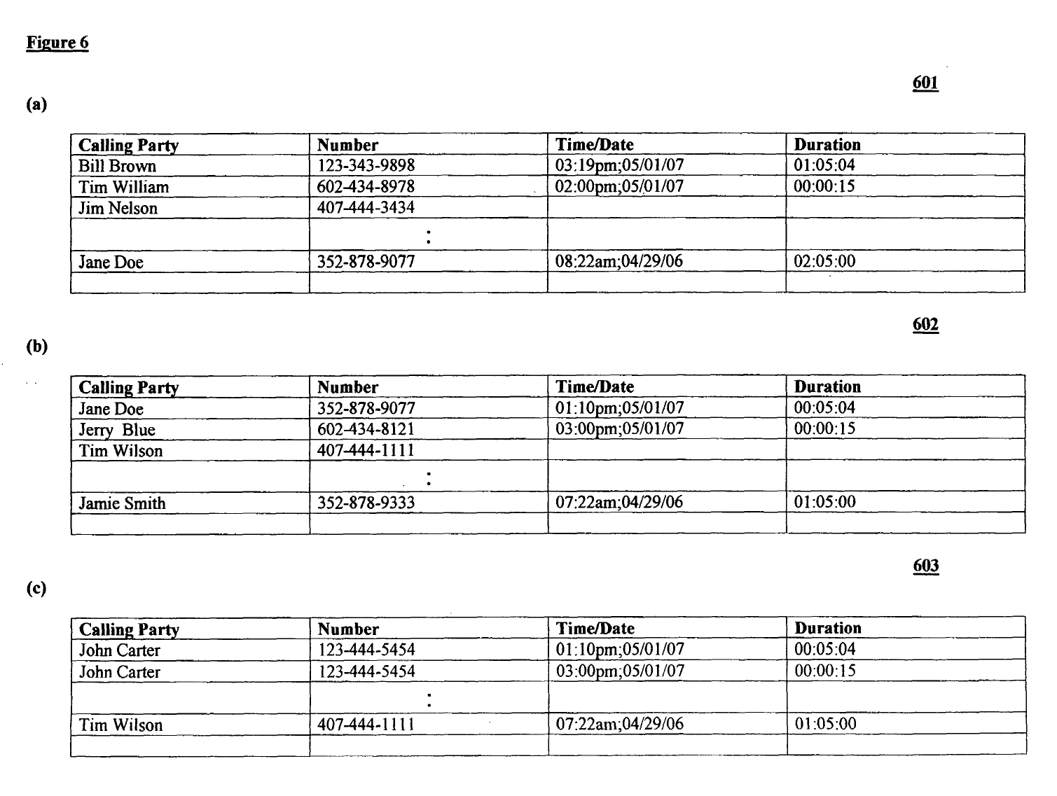

FIG. 6 depicts three tables for an illustrative organization of information in call log 600, in accordance with the illustrative embodiment of the present invention. Call log 600 is a record of call activity that comprises at least a subset of: I. all of the calls made completed to terminal 100 (i.e., “incoming calls”); II. All of the calls originating from terminal 100 (i e., “outgoing calls”); and III. All of the made, but not completed to terminal 100 (i.e., “missed calls”).

At task 301 processor 104 determines what media composition (i.e., making up video ring tone), and what text are to be used to notify the user upon receiving the incoming message, in well known fashion. In some embodiments, terminal 100 might play a particular media composition for all incoming messages, or a media composition that is associated with a category of callers, or a media composition that is associated with an individual caller, etc. As will be appreciated by those skilled in the art, in some embodiments terminal 100 might not output one or more of a video ring tone (VRT) based on preferences set by the user or battery power.

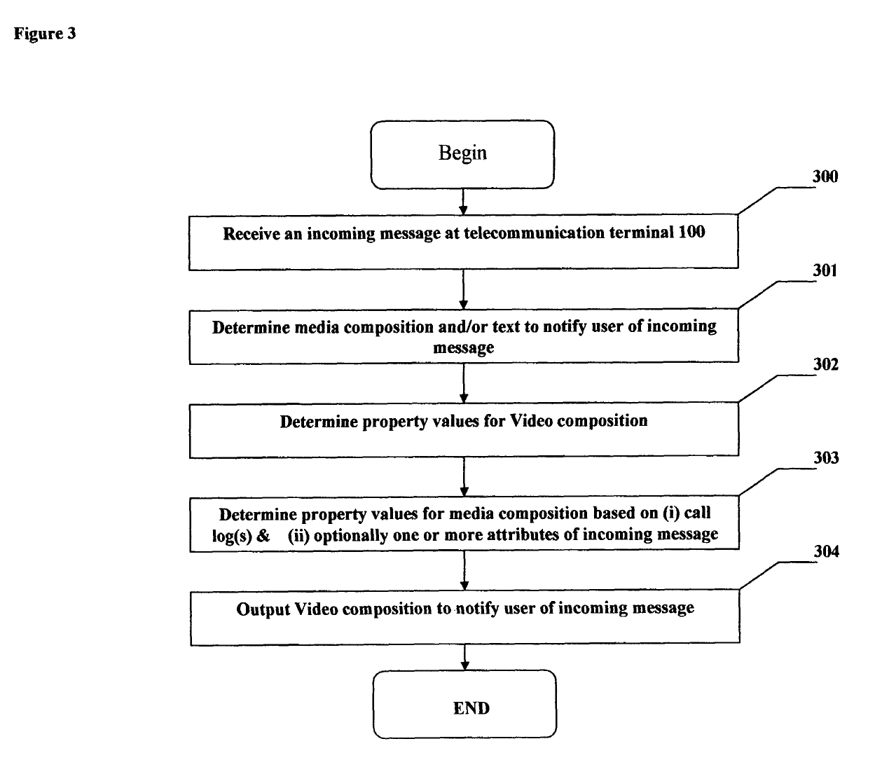

At task 303, processor 104 determines the value, of one or more properties for the media composition that was selected at task 301 based on one or more call logs, as described in detail below and with respect to FIG. 3

Processor 104 retrieves the pertinent information in call log 600 in a accordance with the illustrative embodiment of the present invention. In some alternative embodiments, processor 104 examines only the call log entries (I.e., inbound, out bound, and missed) that include the calling party of the current incoming message described at task 300.

Processor 104 retrieves the pertinent information in call log 600 based on user inputs made at an earlier time (e.g., during initialization of phone service, etc.). The user, in this case either the real user of terminal 100 or an administrator of terminal 100 (e.g., the Information Technology [or IT] person, etc.), has specified the property (e.g., volume, etc.) of an output notification signal (e.g., a media composition, etc.) to vary under a certain condition. The user has also specified the condition on which to modify the property's value. The pertinent information retrieved by processor 104 depends on the condition specified in the user inputs made earlier.

For example, if the condition that is specified in the user input in whether or not the number of times in the same day a call has been received exceeds five then processor 104 searches the incoming call log and missed call log for calls from the same day only. If the property specified for the output notification signal is volume, then processor 104 makes the volume of the video ring tone (VRT) soft for calls one through five and loud for calls five and beyond. Optionally, processor 104 also bases the determining of the one or more properties on one or more attributes of the incoming message.

Incoming log 601 comprises the status of incoming calls. For each incoming call, incoming log 601 comprises: identity (if known) of the originator of the call, also known as the calling party; the telephone number of the calling party: the time and date of the call. The calling party is the person who calls the user of terminal 100.

Out going log 602 comprises the status of outgoing calls. For each outgoing call, outgoing log 602 comprises: the identity of the called party; the telephone number of the called party; the time and date of the call; and the duration of the call. The called party is the person who is called by the user of terminal 90.

Missed log 603 comprises the status of missed calls. For each missed call, missed log 603 comprises: the identity (if known) of the calling party: the telephone number of the calling party; the time and date of the call; and the treatment of the call (if known). The call treatment information, if known, indicates if the call was directed to voicemail, directed to another terminal, or handled in another way.

Call log 600 as depicted in FIG. 6 illustrates a record of telephone calls. It will be clear to those skilled in the art, after reading this specification, how to make and use a call log that provides a record of message activity, where the record of message activity is either integrated with or segregated from the record of telephone call activity. Examples of such messages include e-mail messages, multimedia message service [MMS] messages, instant messages [IM] messages, etc. A call log in terminal 100 or externally to terminal 100 or both.

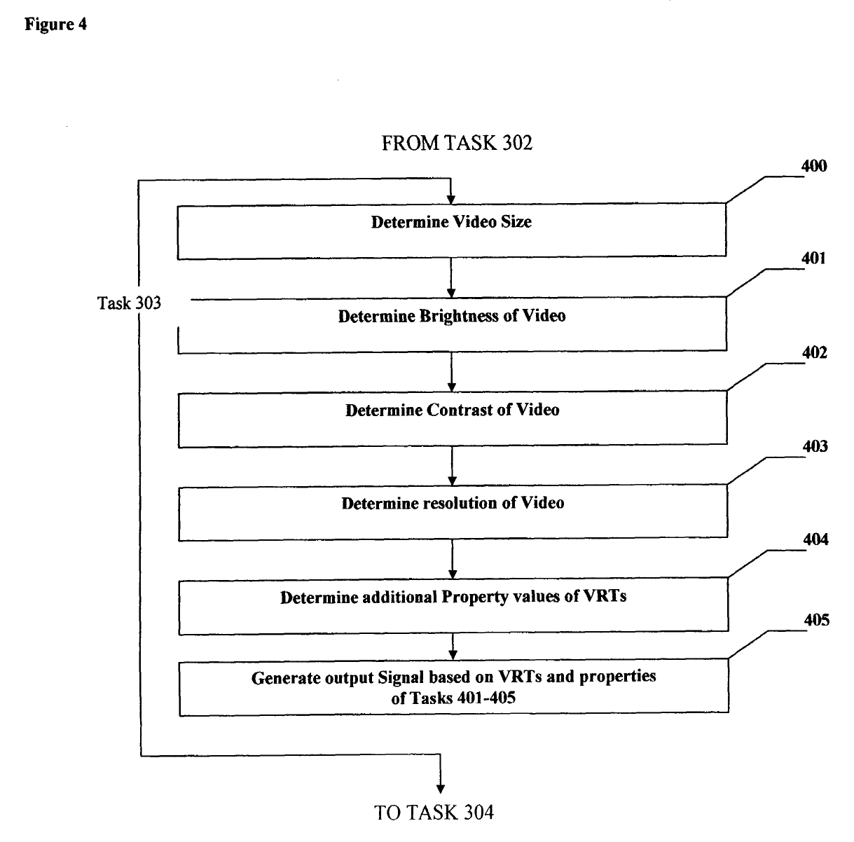

At task 302 processor 104 determines the values of one or more properties for the video piece that was selected at task 301 based on one or more call logs, as described in detail below and with respect to FIG. 4.

Processor 104 retrieves the pertinent information in call log 600 in accordance with the illustrative embodiment of the present invention, as described for task 303.

Optionally, processor 104 also determines the values of one or more properties for the video piece based on attributes of the incoming message. As described for task 301.

At task 304, processor 104 (I) sends a signal to display 106 and speaker 105 to play the video ring tone selected at task 301 in accordance with the property values determined at task 302, (II) sends a signal to display 106 to display text of task 301 (incoming message from Jennifer Dickens, incoming message from 555-555-5555, etc.) in accordance with the property values determined at tasks 303 respectively, in well-know fashion. After task 304 the method of FIG. 3 terminates.

For example, processor 104 examines the caller identifier that is a part of the incoming message. In this example, processor 104 is configured by the user to handle all calls from a particular caller, such as Jennifer Dickens, in a different way than calls form other callers. A media composition such as Samuel Jackson's piece in the motion picture “Pulp Fiction” “I WILL STRIKE DOWN UPON THE WITH GREAT VENGEANCE AND FURIOUS ANGER” this video piece is associated with Jennifer Dickens and can be seen and heard loudly for all of her calls, based on her caller identifier.

Furthermore, the video piece that announces the first call of the day from Jennifer Dickens will be the media composition that announces all other calls of the day from Jennifer Dickens. This video ring tone (VRT) can be seen and heard loudly. In this example, the video and volume of the media composition is determined by an attribute of the incoming message, while the video, volume, tempo of the media composition (music VRT) is determined by information for call log 600. Brightness, volume, tempo are properties that will be described later in this specification.

FIG. 3 depicts a detailed flowchart of task 302 in accordance with the illustrative embodiment of the present invention. It will be clear to those skilled in the art which tasks depicted in FIG. 4 can be performed simultaneously or in a different order than that depicted.

As part of task 303 and based on one or more call logs, terminal 100 determines the values of one or more properties of the video composition determined at task 301, in accordance with the illustrative embodiment of the present invention. The assigned video composition, however, does not change as long as the video composition is in effect.

For example, in the video piece “Pulp Fiction” is the video composition selected, one or more properties of the movie piece might be altered for the purpose of notifying the user. The change in properties can make the video brighter, or sound louder. Nevertheless, it is of particular importance that the user of terminal 100 will still be able to recognize the video piece as “Pulp Fiction” because the video piece remains the same. It will be clear to those skilled in the art how to select which properties are considered and which are not.

At task 500, Processor 104 determines the volume of the video composition, based on the pertinent call log entries. The term “volume” refers to amplitude or loudness of a sound. For example, if Jennifer Dickens has called or instant messaged several times in one day and all her contact attempts wind up as missed (or not responded to), as reflected in the call log, then the volume applied to the user notification of her current incoming message is made louder (or softer) than what was used when she called previously.

At task 505, terminal 100 generates an output notification signal that is based on the video composition and properties of tasks 500-504. For a given video composition, terminal 100 formats the output notification signal, given the video and determined properties, in well-known fashion and in accordance with the illustrative embodiment. In some alternative embodiments, terminal 100 selects the output notification signal based on the determined properties from a set of pre-stored settings.

FIG. 3 depicts a detailed flowchart of task 303 in accordance with the illustrative embodiment of the present invention. It will be clear to those skilled in the art which tasks depicted in FIG. 3 can be performed simultaneously or in a different order than that depicted.

At task 400, processor 104 determines the size of the VRT (video ring tone or media composition), based on the pertinent call log entries. For example, for each incoming message from a given person on a given day, the size of the video in the selected VRT (video ring tone) is made slightly bigger (or smaller) than before. The call log examples provided for the tasks depicted in FIG. 4 also apply to task 400.

At task 401, processor 104 determines the brightness, or “luminosity”. The term “brightness” refers to the intensity of the energy output of visible light of the media composition, based on the pertinent call log entries. The call log examples provided from the tasks depicted in FIG. 4 also apply to task 401, in that the brightness is increased (or decreased) from one incoming message to another, depending on the information in call log 600.

At task 402, processor 104 determines the contrast of the media composition, based on the pertinent call log entries. The term “contrast” refers to the difference in brightness between the light and dark areas of a video. The examples provided from the tasks depicted in FIG. 4 also apply to task 402, in that the contrast is increased or decreased from one incoming message to another, depending on the information in call log 600.

At task 403, processor 104 determines the resolution of the VRT (video ring tone), based on the pertinent call log entries. The term “resolution” refers to the fineness of detail that can be distinguished in an media composition. The call log examples provided for the tasks depicted in FIG. 4 also apply to tasks 403, in that the resolution is increased or decreased from one incoming message to another, depending on the information in call log 600.

At task 404, processor 104 determines the additional properties (e.g., hue, saturation, etc.) of the video piece, based on the pertinent call log entries.

At task 405 terminal 100 generates an output notification signal that is based on the video piece and video piece properties of tasks 400-404. For a given video piece, terminal 100 synthesizes the visual signal, given the specific user VRT (media composition) and the determined properties, in well-known fashion and in accordance with the illustrative embodiment. In some alternative embodiments, user of terminal 100 selects the output notification signal based on the preferences of the user, and downloads media composition form a media web store to be assigned as a VRT.

Terminal 100 displays text as part of the output notification signal, where the semantic content of (i.e., the meaning conveyed by) the notifying text is independent of call log 600, in accordance with the illustrative embodiment, but not necessarily independent of the incoming message. For example, if the incoming call is from Jennifer Dickens terminal 100 might display “Incoming Call” or “Incoming Call from Jennifer Dickens” or “Incoming call from 555-555-5555.” It will be clear to those skilled in the art how to create a notifying text message.

It is to be understood that the above-described embodiments are merely illustrative of the present invention and that many variations of the above described embodiments can be devised by those skilled in the art without departing from the scope of the invention. Those skilled in the art will recognize, however, that the invention can be practiced without one or more of those details, or with other methods, materials, components, etc.

Furthermore, in some instances, well-known structures, materials, or operations are not shown or described in detail to avoid obscuring aspects of the illustration embodiments. It is understood that the various embodiments shown in the Figures are illustrative, and are not necessarily drawn to scale. Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Consequently, the appearances of the phrase “in one embodiment,” or “in some embodiments” in various places throughout the specification are not necessarily all referring to the same embodiment. Furthermore, the particular features, structures, materials or characteristics can be combined in any suitable manner in one or more embodiments. It is therefore intended that such variation be included within the scope of the following claims and their equivalents.

What is claimed:

1. A method comprising (a) receiving a first message at a telecommunications terminal and (b) determining the value of a property for a visual/audio ring tone, motion picture piece or music video piece for notifying the user of said telecommunications terminal of the arrival of said first message or call, and wherein a visual video/audio piece is independent of said property.

2. The method of claim 1 wherein said property is one of video, volume, and sometimes tempo.

3. The method of claim 1 wherein the determination of said property is also based on an attribute of said first message.

4. The method of claim 1 wherein animated video, audio ring tones can be purchased from a online media store for download.

5. The method of claim 1 wherein the determination of said property is also based on an attribute of said message.

6. The method of claim 1 wherein the determination of said property is also based on the number of times the originator of said first message has attempted to contact the user of said telecommunications terminal during a time interval.

7. The method of claim 1 wherein the determination of said property is also based on the time of the most recent prior communication from the originator of said first message.

8. The method of claim 1 wherein the determination of said property is based on an entry in said call log for a second message that is sent to the originator of said first message.

9. A method comprising (a) receiving a first message at a first telecommunication terminal: and (b) determining the value of a property of a motion video/audio ring tone based on the contents of a call log for messages received at a second telecommunications terminal; wherein said motion video/audio is a ring tone for notifying the user of said first telecommunications terminal of the arrival of said first message, and wherein a video piece (motion picture/music video) is independent of said property.

10. The method of claim 9 wherein said first message is sent from a telecommunications terminal other than said second telecommunications terminal.

11. The method of claim 9 wherein said property is one of motion video and volume.

12. The method of claim 9 wherein the determination of said property is also based on an attribute of said first message.

13. The method of claim 9 wherein the determination of said property is also based on the identity of the originator of said first message.

14. The method of claim 9 wherein the determination of said property is also based on the contents of a call log for messages received at said first telecommunication terminal.

15. A method comprising (a) receiving a first message at a first telecommunications terminal; and (b) determination the value of a property for a motion video/audio based on the contents of a call log for messages sent from a second telecommunications terminal; wherein said video/audio composition is a animated video ring tone for notifying the user of said first telecommunications terminal of the arrival of said first message, and wherein a video of said motion picture/music video is independent of said property.

16. The method of claim 15 wherein the user of said first telecommunications terminal is the user of said second telecommunications terminal.

17. The method of claim 15 wherein said first message is from a telecommunications terminal other than said second telecommunications terminal.

18. The method of claim 15 wherein said property is one of motion video, and volume.

19. The method of claim 15 wherein the determination of said property is also based on an attribute of said first message.

20. the method of claim 15 wherein the determination of said property is also based on the contents of a call log for messages received at said first telecommunications terminal.
